(19) United States
(12) Patent Application Publication
(10) Pub. No.: US 2026/0044898 A1
(43) Pub. Date: Feb. 12, 2026

(54) NFT SERVICE SYSTEM

(71) Applicants: HYUNDAI MOTOR COMPANY, Seoul (KR); Kia Corporation, Seoul (KR)

(72) Inventor: Minhan KIM, Hwaseong-si (KR)

(21) Appl. No.: 19/233,498

(22) Filed: Jun. 10, 2025

(30) Foreign Application Priority Data
Aug. 6, 2024 (KR) 10-2024-0104894

(51) Int. Cl. G06Q 40/06; G06F 21/10; G06F 21/60

(52) U.S. Cl. CPC G06Q 40/06; G06F 21/1014; G06F 21/602

(57) ABSTRACT

A non-fungible token (NFT) service system connected to a terminal of an owner or a user comprises: a blockchain mainnet configured to issue an NFT based on manufacturing characteristic information of a vehicle, and a system server implemented using a plurality of processors. The system server is configured to generate (i) a vehicle character representing the vehicle and (ii) an owner character or user character representing the owner or user, respectively, and associate the vehicle character and the owner character or user character to the NFT.

### CROSS-REFERENCE TO RELATED APPLICATION

This application claims priority to and the benefit of Korean Patent Application No. 10-2024-0104894 filed in the Korean Intellectual Property Office on Aug. 6, 2024, the entire contents of which are incorporated herein by reference.

### TECHNICAL FIELD

The present disclosure relates to a non-fungible token (NFT) service system for generating physical vehicle-based NFTs and providing services using the generated NFTs.

### BACKGROUND

Non-fungible tokens (NFTs) are virtual tokens that leverage blockchain technology to establish and verify ownership of digital assets. They are used to represent the unique originality and ownership of digital files, such as images, videos, and other content, by embedding the digital file's address within the token. For example, NFTs function as virtual certificates of authenticity. Each NFT is unique and indivisible, similar to a national ID card that cannot be duplicated. Their uniqueness and provenance are ensured through permanent, immutable transaction records maintained on the blockchain.

NFTs have broad applicability across various technologies, offering enhanced user convenience and enabling the creation of new forms of value.

### SUMMARY

The present disclosure is directed to a system that applies NFTs to real vehicles and services that can be associated with the NFTs.

According to one aspect of the subject matter described in this application, a non-fungible token (NFT) service system connected to a terminal of an owner or a user can include: a blockchain mainnet configured to issue an NFT based on manufacturing characteristic information of a vehicle, and a system server, implemented using a plurality of processors. The system server can be configured to generate (i) a vehicle character representing the vehicle and (ii) an owner character or a user character representing the owner or user, respectively, and associate the vehicle character and the owner character or user character to the NFT.

Implementations according to this aspect can include one or more of the following features. For example, the system server can be configured to issue a derivative NFT associated with the NFT through the blockchain mainnet, the derivative NFT being associated with the user, store information of the user in a block of the blockchain mainnet by using the derivative NFT, and use the derivative NFT to authenticate the user on the blockchain.

In some examples, the system server can be configured to, based on a change in information regarding the user in a metaverse being detected, update changed information in the blockchain using the derivative NFT. In some examples, the system server can be configured to store, to the blockchain associated with the NFT, at least one of changes in vehicle characteristics or changes in ownership, and store, in the blockchain associated with the derivative NFT, information regarding the changes.

In some implementations, the system server can be configured to provide, to the terminal, access to a vehicle production process. In some examples, the system server can be configured to, based on the owner of the vehicle being identified, set a permission for the owner character to access the vehicle production process in a metaverse, and provide, to the terminal of the owner, access to the vehicle production process in response to metaverse connection of the owner character through the terminal of the owner.

In some implementations, the system server can include a database including direct and indirect information regarding each of the vehicle and the owner or the user; a first processor configured to obtain text and prompts representing attributes of a character subject from the information stored in the database; a second processor configured to obtain character metadata for generating the character, represented as vector values or numerical data, based on attributes inherent to the text and the prompts; a graphics AI processor configured to generate the character using the information stored in the database and the character metadata; and an Application Processor Interface (API) providing an interface between the first processor, the second processor, the graphics AI processor, and the database.

In some examples, the first processor can be configured to perform morphological analysis to remove one or more contents from sentences utilized by the owner or the user within a text collection environment, collect text based on content words by excluding non-words from sentences utilized by the owner or the user, apply text mining to the collected text to structure collected data, and apply text analysis to the structured text to obtain quantified data regarding the structured text. In some implementations, the system server can further include a third processor configured to tune a character received from the terminal based on the character metadata, where one of the character generated by the second processor, the character tuned by the third processor, or the character received from the terminal to the system server can be determined and delivered to the database via the API, and the database can be configured to store the character delivered via the API by matching the character to a corresponding subject.

In some implementations, the system server can include a database including direct and indirect information regarding the vehicle and the owner or the user; a fourth processor configured to obtain text and prompts including voice metadata for generating voice from the database; a fifth processor configured to generate voice metadata from the text and prompts; a voice model database storing voice data according to a plurality of factors; a voice AI processor configured to generate voice data corresponding to the voice metadata using the voice data stored in the voice model database; and a voice generation processor configured to convert the voice data corresponding to the voice metadata into digital signals to generate voice signals.

In some examples, the voice AI processor can be configured to perform AI learning to generate voice data corresponding to the voice metadata using a plurality of voice data from the voice model database. In some implementations, the voice generation processor can be configured to acquire dialogue styles and words according to the character, and word and style information used by a group to which the owner or the user belongs from the voice model database, and convert the voice data corresponding to the voice metadata into digital signals to generate voice signals according to the acquired dialogue styles, words, and style information.

In some implementations, the system server can further include: an API configured to deliver a voice signal selected by the owner or the user via the terminal, and a voice signal generated or tuned using the terminal received from the terminal to the voice model database, where the voice model database can be configured to store the voice signal delivered from the API by matching the voice signal to at least one of the owner or the user, the character of the owner or the user, or a group to which the owner or the user belongs.

In some implementations, the system server can include a data processing processor configured to process video data to extract motion data regarding movements of a person or movements of an object representing actions, and convert the extracted motion data into animation to generate animation data; and a motion AI processor configured to combine the animation data into animation motion data using an AI algorithm. In some implementations, the system server can be configured to provide generation of a plurality of NFTs for a plurality of contents, and providing an NFT market by associating the plurality of contents to the plurality of NFTs, and associate an NFT purchased in the NFT market to the NFT of the vehicle in response to a request from the owner or the user.

### BRIEF DESCRIPTION OF THE DRAWINGS

FIG. 1 is a block diagram illustrating an example of a service system using an NFT.

FIG. 2 is a diagram illustrating an example of a relationship between an NFT and a derivative NFT of a user.

FIG. 3 is a diagram illustrating an example of a character creation process.

FIG. 4 is a block diagram illustrating an example of a system server.

FIG. 5 is a diagram illustrating an example of a text-to-image conversion method.

FIG. 6 is a block diagram illustrating an example of configurations for determining a voice for a character in the system server.

FIG. 7 is a block diagram illustrating an example of configurations for determining an operation for a character in the system server.

FIG. 8 is a block diagram schematically illustrating an example of an NFT market within a metaverse environment.

### DETAILED DESCRIPTION

A service system can utilize dynamic non-fungible tokens (NFTs). Unlike traditional NFTs, which are issued with fixed metadata that remains unchanged, dynamic NFTs allow for updates to their metadata after issuance. These updates can be triggered by external conditions through the use of smart contracts. For example, a smart contract may change the metadata in response to a change in real-world data, and subsequently update the visual representation of the NFT based on the revised metadata.

In some examples, the external condition may include information such as vehicle history, driving records, or owner changes. The smart contract can then change the NFT accordingly. The updated NFT can also be applied in a metaverse environment to reflect real-time changes in digital or physical assets.

A smart contract is a self-executing digital agreement embedded in the blockchain software. The conditions required for its execution are predefined within the contract. A smart contract may be implemented as an application executed by a processor that combines software and hardware elements. Since blockchain operations are carried out via execution of software on a blockchain mainnet, a smart contract application is typically run on the blockchain mainnet. Hereinafter, the term “on a blockchain” refers to one or more blockchains constituting a “blockchain mainnet” or to a specific blockchain in context.

The blockchain mainnet may incorporate a chain-link oracle, which enables smart contracts to access external data. Such data may include off-chain information retrieved via external application program interfaces (APIs). A chain link oracle may include a plurality of chain link nodes interconnected over a network, capable of interfacing with external systems through adapters. These chain link oracles may also be implemented using a combination of software and hardware.

An NFT can be issued through a smart contract, which can manage the creation, ownership, and trading of NFTs on the blockchain. NFTs may be minted as identifiers based on standard token formats and store on chain, i.e., directly within the blockchain. In some implementations, associated metadata and media files can be stored off-chain, outside of the blockchain environment.

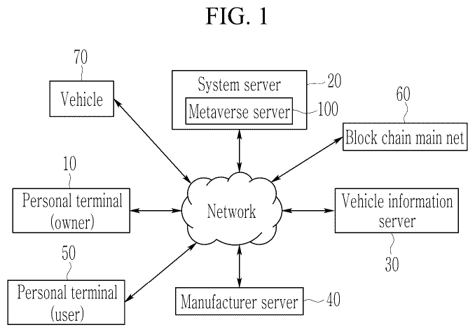

FIG. 1 is a block diagram illustrating an example of a service system using an NFT.

As depicted in FIG. 1, an NFT service system 1 can include personal terminals 10 and 50, a system server 20, a vehicle information server 30, a manufacturer server 40, and a blockchain mainnet 60. In the NFT service system 1, the personal terminals 10 and 50, the system server 20, the vehicle information server 30, the manufacturer server 40, the blockchain mainnet 60, and a vehicle 70 can be connected to each other through a network, and can transmit and receive information for providing or receiving services using NFTs.

The personal terminal 10 can refer to a device with an application installed for utilizing various NFT-based services by the vehicle owner. The personal terminal 50 can refer to a terminal on which an application for utilizing various services based on NFTs by a user of the vehicle has been installed. A user of the vehicle may refer to a person using the vehicle 70 other than the owner of the vehicle. In some implementations, the owner and the user of the vehicle can be referred to collectively as the “user side” or the owner of the vehicle and the user of the vehicle can be referred to separately. The NFT service can be provided to a user side through an application executed on the personal terminals 10 and 50. The personal terminals 10 and 50 can be a PC, a smart device, or the like on the user side, or a vehicle that includes a wireless communication device and is equipped with an operating system capable of operating the application.

The manufacturer server 40, operated by the vehicle manufacturer, can transmit vehicle manufacturing characteristic information to the system server 20. Based on the commands provided by the system server 20 and the vehicle manufacturing characteristic information, the blockchain mainnet 60 can issue NFTs based on the vehicle manufacturing characteristic information. In some implementations, the system server 20 can include a blockchain mainnet that issues NFTs based on the manufacturing characteristic information of the vehicle. The blockchain mainnet 60 can be based on a private blockchain. The smart contract on the blockchain mainnet 60 can be executed to issue an NFT. The NFT can be minted and issued to be associated with a vehicle unique key corresponding to the vehicle, a character matched to the NFT (NFT character), and vehicle owner and/or user information. The owner and/or user information can be stored on the associated system server 20, and the NFT character can be stored in the system server 20 as a vehicle character corresponding to the vehicle. The smart contract application can retrieve character, owner, and/or user information from the system server 20 through the chain link oracle. Minting and issuing NFTs and issuing NFTs can be understood to have the same meaning.

The present disclosure does not limit the time when NFTs is issued. For example, an NFT for a corresponding vehicle can be issued at the start of the production process. When the conditions for executing the smart contract are satisfied at the start time of the vehicle production process, such as determining the owner of the vehicle, specifying unique information about the vehicle, and confirming the existence of vehicle information, the smart contract can issue NFTs on the blockchain from the start time of the vehicle production process. As the production process progresses, the metadata of the NFT can be updated according to new information provided by the relevant server.

In some implementations, an NFT can serve as a means of holding value. An NFT can be generated based on a vehicle unique key, a vehicle unique code, a unique serial number, or the like, so that the NFT can demonstrate the uniqueness of the corresponding vehicle and its association with the vehicle. The NFT can be traded in conjunction with the vehicle transaction, or can be traded independent if the vehicle is no longer available. Through the NFT, an owner and/or a user of a vehicle can be authenticated, and permissions to use to an NFT character associated with the NFT in the metaverse and within the vehicle can be granted.

The system server 20 can generate a vehicle character representing the vehicle 70, and generate an owner character or user character, which is a character representing an owner or user. In the following description, the meaning of “owner character or user character” can include an owner character, a user character, and both an owner character and a user character. Additionally, descriptions of a user character can be applied equally to an owner character, and vice versa.

The system server 20 can associate a vehicle character with an NFT based on unique information of the vehicle. The system server 20 can associate an owner character or a user character with the NFT along with the vehicle character. The system server 20 can generate a vehicle character, an owner character, and a user character before issuing NFTs and associate the generated vehicle character, owner character, and user character with the NFTs after issuing NFTs. The system server 20 can generate a vehicle character, an owner character, and a user character after issuing NFTs and associate the generated vehicle character, owner character, and user character with the NFTs. In the following description, an NFT character can include the vehicle character, the owner character, and the user character associated with the NFT. An owner character or user character can be implemented as an owner avatar or user avatar matched to an owner or user. The system server 20 can change and update the vehicle character in response to changes in information about the vehicle and/or the user side, generate a new user character or owner character when a user is added to the user side or the owner changes, and change and update the user character or owner character in response to changes in the information about the user or owner. Hereinafter, a user-side character can refer to a collective expression of a user character and an owner character.

The system server 20 can further include a metaverse server 100. A vehicle character and a user-side character provided by the system server 20 can represent the vehicle 70 and the owner or the user in a metaverse environment provided by the metaverse server 100. The vehicle and user-side characters can be used both in the vehicle and the metaverse. For example, a vehicle character can be utilized to represent a vehicle in the AVN system of the vehicle 70, an owner character, for example, an owner avatar, can be utilized to represent an owner of the vehicle, and a user character, for example, a user avatar, can be utilized to represent a user of the vehicle.

The vehicle information server 30 can be a server operated by entities involved in the characteristic change of the vehicle, for example, a server or terminal of a vehicle repair shop, a server or terminal of a vehicle parts manufacturer, a server or terminal of an industrial company that repairs and/or tunes vehicles, and a server of an insurance company that generates vehicle accident history, or can be connected through a network to collect information about the characteristic change of the vehicle from each of these servers or terminals. The vehicle information server 30 can collect the vehicle characteristic change and transmit the collected characteristic change to the system server 20. The system server 20 can update or change the NFT character by reflecting the vehicle characteristic change.

The personal terminal 50 can be a personal terminal accessed by a purchaser who has traded a vehicle and/or NFT with the user side. Transactions between personal terminals 10 and 50 can be facilitated through an application supporting vehicle and/or NFT transactions. The corresponding application can provide the transaction history to the system server 20. The system server 20 can change the NFT character and/or change the user-side character based on the transaction of the vehicle and/or NFT. For example, when a vehicle is traded, the system server 20 can generate a new owner character, such as an owner avatar, and associate the generated owner character with the NFT. Then, the owner avatar corresponding to the NFT character can be changed. However, vehicle information, history, and NFTs remain immutable as records on the blockchain. The vehicle history can include information about accidents, repairs, maintenance, tuning, and similar details of the vehicle.

Vehicles can refer to a movable property with property value. By their nature, vehicles can be shared by multiple owners, have different owners and users, or have multiple users in addition to the owner. In addition, there are cases where a vehicle owned by a legal entity is operated by multiple people, such as a lease or rental. Therefore, multiple avatars can represent the user side. The plurality of avatars can be derived from and associated with NFT characters utilized in the metaverse or on the vehicle.

After issuing the NFT associated with the vehicle, the system server 20 can issue derivative NFTs for each user other than the owner of the corresponding vehicle through the blockchain mainnet 60. By using each of the derivative NFTs, the system server 20 can store information of each user in a block of the blockchain mainnet 60 and use the derivative NFT corresponding to each user for authentication of each user on the blockchain. The system server 20 can issue derivative NFTs in association with the NFTs on the blockchain mainnet 60. The system server 20 may not issue standalone derivative NFTs and may not allow their independent trading. The system server 20 can verify that the user is authorized as a user of the corresponding vehicle. The system server 20 can obtain information for the verification through the personal terminal 50. The system server 20 can provide transactions for NFTs based on vehicle transactions or transactions for NFTs alone, but not provide transactions for derivative NFTs alone. The system server 20 can store and manage information regarding the owner and the history of the owner's changes on the blockchain by using NFTs. When there is a change in information regarding a user in the metaverse, the system server 20 can update the changed information on the blockchain by using a derivative NFT corresponding to the user whose information has changed. User activities in the metaverse can then be recorded on the blockchain via their respective derivative NFTs. That is, the derivative NFTs can be utilized independently of the NFTs in the metaverse.

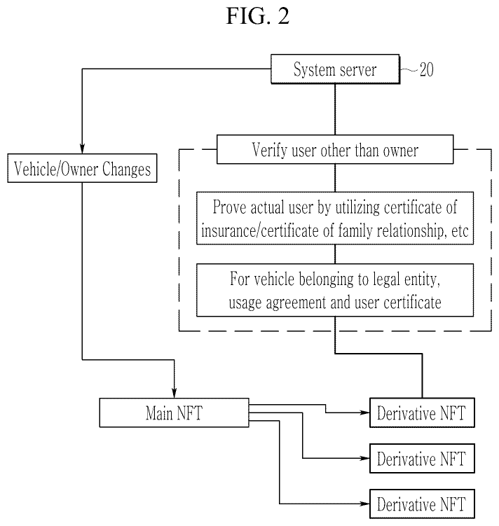

FIG. 2 is a diagram illustrating an example of a relationship between an NFT and a derivative NFT of a user.

When changes are made to the vehicle and/or the owner, the system server 20 can store the changed information on the blockchain by using NFTs.

The system server 20 can authenticate non-owner users to issue derivative NFTs. The system server 20 can authenticate the user by comparing a vehicle insurance certificate provided through the personal terminal 10 with an insurance certificate obtained from a server of a corresponding insurance company. In addition or alternatively, the system server 20 can authenticate the user using a certificate of family relationship between the vehicle owner and the user provided through the personal terminal 10. When the vehicle is owned by a legal entity, the system server 20 can authenticate the user by using a user certificate and a usage agreement between the legal entity and the user provided through the personal terminal 10. When the user has been authenticated, the system server 20 can issue a derivative NFT associated with the NFT for each user. For multiple users, the system server 20 can issue multiple derivative NFTs, as depicted in FIG. 2. The system server 20 can record and store changes in vehicle characteristics and/or changes in a vehicle owner in the blockchain in association with the NFT, and record and store the recorded and stored change information associated with the NFT in the blockchain in association with a plurality of derivative NFTs in the blockchain. For example, a new record associated with the NFT can be generated as a new block to constitute the block chain, and the new block for the NFT can also be associated with the derivative NFTs of the NFT.

To collect information regarding a purchaser, the following methods can be commonly applied: 1) a method of inducing a purchaser to enter the information directly on a website or application that is capable of collecting purchaser's information, 2) a method of collecting an email address or phone number of a purchaser, 3) a method of recognizing a purchase history of a purchaser, and 4) a method of collecting social media information of a purchaser. Data mining techniques can be used to extract metadata or related information from the collected purchaser's information. Data mining can refer to the technique of finding patterns or rules in large amounts of data, and can utilize statistical analysis, machine learning, and artificial intelligence techniques. For example, from a shopper's purchase history data, information, such as each shopper's gender, age, residential location, product type, and payment method, can be extracted, and through the extracted information, the popularity of products by gender and age group can be recognized, or the proportion of sales by payment method, and the like can be analyzed. In addition, purchasers' tastes, preferences, interests, and the like can be extracted from the social media information. The extracted data can be used to identify purchaser behavior patterns and inform product recommendation systems.

The present disclosure provides a vehicle character and an owner character or user character in the metaverse to obtain customer data. From the time the owner contracts for the vehicle, the owner unreservedly provides owner information to the system server 20 through the owner terminal. This information is used to generate the vehicle character and the owner avatar which is the owner character. Because the owner actively and candidly provides the data, the manufacturer can collect highly accurate and specific owner data accumulated in the system server 20. The user can provide user information to the system server 20 through the user terminal to generate a user avatar, which is a user character, while utilizing the vehicle.

The owner can set a preferred vehicle character and/or avatar character and input text and/or prompts with metadata about the owner's characteristics directly through the personal terminal 10. The user can set a preferred avatar character and input text and/or prompts with metadata about the user's characteristics directly through the personal terminal 50. The system server 20 can extract the input owner and user characteristics and provide the extracted owner and user characteristics to the manufacturer for utilization in vehicle development. Owner and user characteristics can be stored in a database for creating vehicle and avatar characters tailored to the preferences of various owners and users. In this way, the collected owner and user characteristics can be databased and accumulated, and the accumulated data can be used for product development and the creation of the vehicle character and the owner and user characters. The system server 20 can extract patterns and rules from the accumulated data, and extract metadata representing characteristics for each of the owner and user based on the patterns and rules. The system server 20 can generate vehicle, owner, and user characters using the extracted metadata.

The system server 20 can receive information regarding the vehicle production process from the manufacturer server 40 and provide a view of the vehicle production process to the personal terminal 10 of the owner who will purchase the vehicle. When an owner is assigned to a vehicle, the system server 20 can receive owner information for the corresponding vehicle from the manufacturer server 40, and generate a vehicle character and an owner character before issuing the NFT. For example, when an owner of a vehicle is identified by a vehicle purchase contract, the owner can generate a character for the owner, for example, an owner avatar, on the system server 20 through the personal terminal 10. The system server 20 can set authority to view the production process of the vehicle in the metaverse for the owner character. The system server 20 can provide information about the vehicle production process provided to the system server 20 from the manufacturer server 40 to the metaverse server 100, and the metaverse server 100 can implement the vehicle production process in the metaverse. The owner can access the metaverse as the owner character through an application installed on the personal terminal 10 or through the web. The metaverse server 100 can provide viewing of the vehicle production process in response to accessing the metaverse through the owner character. The system server 20 can grant the owner authority to create an NFT character for the vehicle upon acquisition, allowing the owner to generate the NFT character via personal terminal 10.

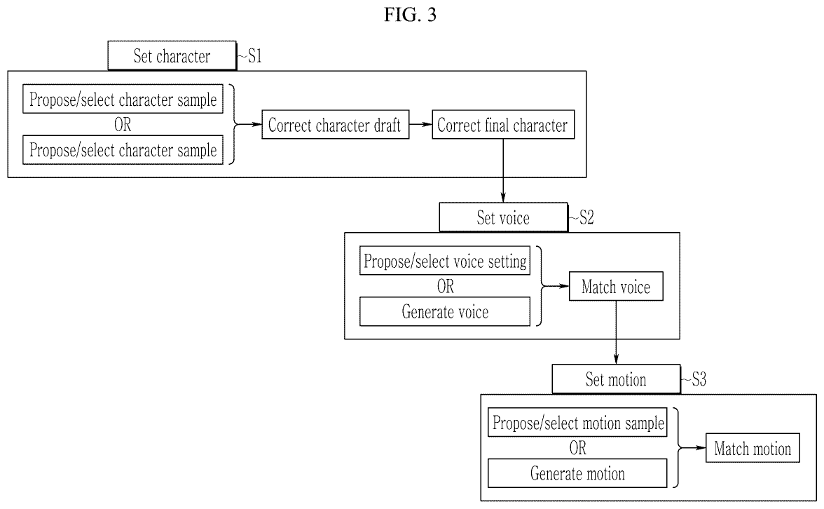

FIG. 3 is a diagram illustrating an example of a character creation process.

First, the system server 20 can set a vehicle character and an owner character (S1).

The system server 20 can present multiple vehicle and owner character samples to the owner via personal terminal 10. The system server 20 can transmit the plurality of samples of the owner character to the personal terminal 10 based on collected characteristics of the owner. For example, the system server 20 can generate a plurality of owner characters based on characteristics, such as the owner's age, gender, preferences, or personality. The system server 20 can transmit a plurality of samples of vehicle characters to the personal terminal 10 based on vehicle information and the characteristics about the owner. For example, the system server 20 can determine a default vehicle character based on the vehicle information, and generate a plurality of vehicle character samples by tuning the default vehicle character in various ways based on the characteristics of the owner. The system server 20 can transmit the generated plurality of vehicle character samples to the personal terminal 10, and the owner can select the vehicle character samples and the owner avatar samples through the personal terminal 10. Alternatively, the owner can generate the vehicle character samples and the owner avatar samples by using an application installed on the personal terminal 10.

The owner can modify the vehicle character sample and the owner avatar sample through an application installed on the personal terminal 10. When the modifications to the vehicle character sample and the owner avatar sample are completed, a final character can be determined. The owner can transmit the completion of the modification to the system server 20 through the personal terminal 10, and the system server 20 can set the vehicle character and the owner avatar by determining the character at the time of completion of the modification as the final character.

The system server 20 can also assign voice data to the vehicle character and owner avatar (S2). The system server 20 can transmit a plurality of voice samples for each of the vehicle character and the owner avatar to the personal terminal 10. For example, the system server 20 can generate a plurality of voice samples for the owner character based on the owner characteristics and the owner avatar, and a plurality of voice samples for the vehicle character based on the vehicle information and the vehicle character. The system server 20 can transmit the generated plurality of voice samples to the personal terminal 10, and the owner can select a voice sample for each of the vehicle character and the user avatar through the personal terminal 10. Alternatively, the owner can create custom voices for the vehicle and owner characters using an application on personal terminal 10. The voice samples can include voice data that indicates the frequency components, wave shape, loudness, and the like of the voice.

The system server 20 can match the selected voice sample or the owner-generated voice sample to the owner character.

The system server 20 can also assign motion data to the vehicle and owner characters (S3). The system server 20 can transmit a plurality of motion samples for each of the vehicle character and the owner character to the personal terminal 10. For example, the system server 20 can generate multiple motion samples for the owner character based on the owner's characteristics. The system server 20 can transmit the generated plurality of motion samples to the personal terminal 10, and the owner can select at least one motion sample for the owner character through the personal terminal 10. Alternatively, the owner can generate at least one motion for each of the vehicle owner characters through an application installed on the personal terminal 10.

In the description of FIG. 3, only the owner is mentioned, but the user character can be implemented in the same way.

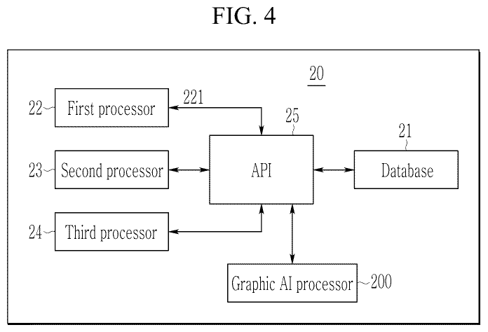

FIG. 4 is a block diagram illustrating an example of a system server.

As depicted in FIG. 4, the system server 20 can include a database 21, a first processor 22, a second processor 23, a third processor 24, a graphic artificial intelligence (AI) processor 200, and an application processor interface (API) 25. Each of the plurality of processors 22, 23, 24, and 200 can execute an installed application. The API 25 can provide interfacing between the plurality of processors 22, 23, 24, and 200, interfacing between each of the plurality of processors 22, 23, 24, and 200 and the database 21, and interfacing between the external network and the system server 20.

The database 21 can store and manage various information regarding each of the plurality of vehicles. For example, the various information regarding each of the plurality of vehicles can include the planning intent of the vehicle, information regarding prospective demanders, information regarding purchasers, preferences of the purchaser, ages, tastes, and preferences of the primary customers, and the like. In addition, the database 21 can store information regarding multiple vehicle characters, owners, and user characters. The database 21 can include direct information and indirect information regarding each of the vehicle and the owner and/or user. The direct information can include responses to surveys, responses and the like to certain well-intentioned questions asked of prospective demanders and actual demanders in the character creation process. Indirect information can include background information regarding the owner and user, such as age and occupation, as well as information obtained through methods not specifically intended for character creation. Information regarding purchasers and prospective demanders can be based on analysis data of the needs of actual purchasers targeted by OEMs that have not resulted in actual purchases. The vehicle's planning intent can be derived from analyzing prospective buyer data. The information to be stored in the database 21 can be represented as text and prompts with metadata, and clarify direct or indirect information about future actual purchasing customers or users, or obtain differences from predictions.

The first processor 22 can extract text and prompts representing attributes of the character's object from the information stored in the database 21. The first processor 22 can detect, from the information stored in the database 21, information for generating a vehicle character, text and prompts regarding the vehicle based on the detection contents, detect information for generating an owner or user character, and generate text and prompts regarding the owner or the user based on the detection.

The first processor 22 can collect the text by performing morphemic analysis to remove unnecessary or irrelevant content from the sentences utilized by the owner or the user within the text collection environment. Further, the first processor 22 can collect text based on content words, such as nouns, verbs, and adjectives, while excluding non-words, such as articles, from the sentences utilized by the owner or the user. The first processor 22 can apply text mining to the collected text to identify textual patterns and trends in the unstructured data to structure the text. The first processor 22 can use text analytics on the structured text to derive quantified insights. The second processor 23 can extract metadata for character generation (hereinafter, character metadata) from the text and the prompt. The “text” and “prompt” can be sources for obtaining character metadata for generating a character associated with the NFT, such as a vehicle character, an owner character, and a user character. The “text” can include contents of the characteristics of the vehicle, owner, user, and the like for obtaining the character metadata. The “prompt” can include inputs, questions, tasks, instructions, contexts, output types, and the like for the process of obtaining character metadata through artificial intelligence.

The second processor 23 can generate character metadata represented as vector values or numerical values based on attributes inherent in each of the text and prompts. To build a model using machine learning or deep learning, which are examples of AI learning, the text and prompt need to be converted into metadata as vector values or numbers that the computing device can understand. For example, the second processor 23 can map words or phrases in the text and prompts to real-number vectors through word embedding and word vectorizing. Specific implementation methods can leverage known techniques, enabling the second processor 23 to extract character metadata necessary for character generation. The graphic AI processor 200 can generate the character by using the obtained character metadata. The vehicle character, the owner character, and the user character can be collectively referred to as “characters” in the present disclosure.

The graphic AI processor 200 can generate a vehicle character by using information and character metadata associated with the vehicle in the database 21, and generate an owner character or user character by using information and character metadata matching the owner or the user in the database 21. The information associated with the vehicle in the database 21 can include vehicle images, photographs, 3D data, and the like, and the information matching the owner or the user in the database 21 can include tastes and preferences for appearance, and the like in the owner's age or the user's age range.

The graphics AI processor 200 can build an AI model by learning to image text representing character metadata (hereinafter, character text). The graphic AI processor 200 can apply various known text-to-image conversion AI models. For example, the graphics AI processor 200 can be implemented with one or a combination of two or more of a diffusion probabilistic model that incrementally adds noise to data and then learns to generate data from the noise, a latent space model that applies diffusion to image embedding instead of image pixels, and the like.

Character text can be input to the graphic AI processor 200, and the graphic AI processor 200 can image the character text to generate the character.

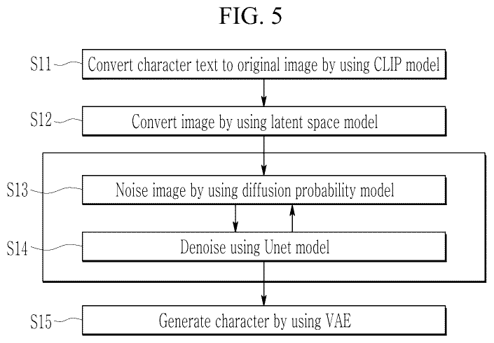

FIG. 5 is a diagram illustrating an example of a text-to-image conversion method.

The graphic AI processor 200 can encode the character text through a contrastive language-image pre-training (CLIP) model and convert the encoded character text to a certain image (hereinafter, the original image) (S11). The certain image can include a plurality of image tokens corresponding to the character text. The CLIP model can be built by training to pair a plurality of texts in which character text is encoded with a plurality of images in which various vehicle images, photographs, and 3D data are encoded.

The graphic AI processor 200 can convert the original image implemented as pixel information by using the latent space model into an image in latent space (hereinafter, the latent image) of relatively small dimension (S12).

The graphic AI processor 200 can apply noise to the latent image using a diffusion probabilistic model (S13). The graphic AI processor 200 can perform denoising on the noised latent image by using a UNet model (S14).

The graphic AI processor 200 can repeat operations S3 and S4 a plurality of times to generate a final image in the latent space. For example, the latent image denoised in operation S4 may be noised again through operation S3, and the noised latent image can be denoised again through operation S4. This process can be repeated either a predefined number of times or as determined by training.

The graphic AI processor 200 can apply a Variational Auto encoder (VAE) to the final image to convert the final image to pixel information to generate a character (S15).

The pixel information may increase in size as the resolution increases, and resources of the processor may be used exponentially to process the pixel information. In some implementations, the preceding operation of the diffusion probability model can further include an operation of encoding the text to a latent image in the latent space and an operation of decoding the latent image to pixel information, so that noising and denoising can be implemented in the latent space of much smaller dimension, not in the entire image according to pixel information. As a result, the amount of resource usage can be greatly reduced even for generating images of relatively large resolution, and character generation can be executed on a graphics card of an ordinary home.

The owner can create a vehicle and owner character via personal terminal 10 and transmit them to system server 20. The user can generate a vehicle character and a user character through the personal terminal 50 and transmit the generated vehicle character and user character to the system server 20. The third processor 24 can refine the vehicle characters and owner/user characters received from the personal terminals 10 and 50 based on the character metadata.

The system server 20 can transmit the vehicle character and the owner character generated by the second processor 23, or the vehicle character and the owner character tuned by the third processor 24, to the personal terminal 10. The system server 20 can transmit the vehicle character and the user character generated by the second processor 23, or the vehicle character and the user character tuned by the third processor 24, to the personal terminal 50.

The owner may accept the characters sent to personal terminal 10 by system server 20. Alternatively, the owner can determine the character by accepting or further modifying the tuned character provided to the personal terminal 10 by the system server 20. The user can accept the character provided to the personal terminal 50 by the system server 20. Alternatively, the user can determine the character by accepting or further modifying the tuned character provided to the personal terminal 10 by the system server 20. A finally determined character from among the character generated by the second processor 23, the character tuned by the third processor 24, and the character generated by the owner or the user and received by the system server 20 from the personal terminals 10 and 50 can be transmitted to the database 21 through the API 25.

The database 21 can store the character transmitted through the API 25 by matching the character to a corresponding target among the vehicle, the owner, and the user. The data stored in the database 21 can be used as training data for the graphic AI processor 200 to generate the character from the metadata. FIG. 1 illustrates that the characters are stored in the database 21, but a separate character database may be built. This feedback structure can allow character-related data in database 21 to be updated. Thus, the graphic AI processor 200 can be provided with a circulation learning structure for generating characters and receiving feedback on the characters from owners and users.

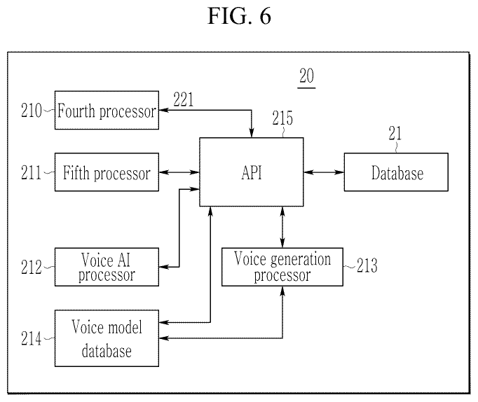

FIG. 6 is a block diagram illustrating an example of configurations for determining a voice for a character in the system server.

As depicted in FIG. 6, the system server 20 can include a database 21, a fourth processor 210, a fifth processor 211, a voice AI processor 212, a voice generation processor 213, a voice model database 214, and an API 215. The database 21 can be configured similarly to the implementation described with respect to FIG. 4.

Each of the fourth processor 210, the fifth processor 211, the voice AI processor 212, and the voice generation processor 213 can execute an installed application, and the API 215 can provide interfacing between the processors 210 to 213 and the database 21.

The fourth processor 210 can obtain the text and prompts for generating voice from the database 21 in a similar manner to the first processor 22. Additionally, the fourth processor 210 can obtain the text and prompts from metadata held by the character generated for the owner or the user, the voice provided by the vehicle, biographical information, such as gender and age, for each of the owner and user, and the like. The fourth processor 210 can detect only the speaker's voice portion of the voice provided by the vehicle and extract voice characteristics from the detected voice.

The fifth processor 211 can generate voice metadata by using the text and prompts provided by the fourth processor 210 in a manner similar to the second processor 23. The fifth processor 211 can generate voice metadata, which may be represented as vector values or numerical values, based on attributes inherent in each of the text and prompts.

The voice AI processor 212 can build an AI model by learning to generate voice data based on the voice metadata obtained by the fifth processor 211, and generate voice data from the voice metadata. Voice data can include information such as speed, intensity, pronunciation, and intonation.

The voice model database 214 can store a plurality of factors that may be considered in generating voice data and voice data based on the plurality of factors. The various factors can include characters generated by the system server 20, words and stylistic styles used by the owner and the group to which the user belongs, and the like.

The voice AI processor 212 can perform AI training to generate voice data corresponding to the voice metadata provided from the fifth processor 211 by using the plurality of voice data stored in the voice model database 214

In this case, applicable training methods can include statistical synthesis methods, deep learning-based synthesis methods, and others. The statistical synthesis method can be one of a hidden Markov model (HMM) based synthesis method or a pitch-synchronous overlap and add (PSOLA) based synthesis method. The HMM-based synthesis method can be a method of dividing the voice signal by a regular unit, identifying the characteristics of each unit, and combining the respective units to generate a voice. The PSOLA-based synthesis method can be a method of generating a new voice by utilizing existing voice components in the voice signal. Deep learning-based synthesis methods can include WaveNet and Tacotron. The WaveNet method can predict the next sampling value based on the previous sampling value of the voice signal to generate a natural sound during the voice generation process by using a deep learning model. The Tacotron method can generate a voice signal based on text of the metadata input to the deep learning model that generates voice from text.

The voice generation processor 213 can generate a voice signal by converting the voice data generated by the voice AI processor 212 into a digital signal. The voice generation processor 213 can adjust the frequency components, waveform shape, loudness, and the like of the voice data to generate a voice signal that approximates human voice. The voice generation processor 213 can select a dialogue style and words based on a character corresponding to the owner or the user. Dialogue styles and vocabulary for each character can be stored in the voice model database 214. The voice generation processor 213 can generate sentences by using the dialogue style and words selected based on the character, make the generated sentence into voice, and generate a voice signal. Alternatively, the processor can retrieve common words and stylistic features used by the owner's or user's group from the voice model database 214. Further, the voice generation processor 213 can obtain words and stylistic information that are commonly used by the owner or the user from the voice model database 214. Furthermore, the voice generation processor 213 can select one of the honorifics or casual speech. The voice generation processor 213 can convert the voice data into a digital signal to generate a voice signal based on the obtained dialog, words, and stylistic information, and the selected honorific or casual speech. The voice generation processor 213 can provide the generated voice signal to the API 215, and the voice signal can be transmitted to the personal terminal 10 or 50 of the owner or the user through the API 215.

When the system server 20 can generate a voice signal based on the voice metadata and transmit the generated voice signal to the personal terminal 10 or 50, the owner or the user can select the received voice signal through the personal terminal 10 or 50. Alternatively, the owner or the user can modify the provided voice signal through a voice tuning application installed on the personal terminal 10 or 50 or through the web that provides a voice tuning function. Alternatively, the owner or the user can generate the voice signal by using a voice generation application installed on the personal terminal 10 or 50 or the web providing a voice generation function. When the voice signal is modified or generated, as opposed to being selected by the personal terminal 10 or 50, the owner or the user can adjust a plurality of components of the voice signal by using the voice tuning application/web, or can generate the voice signal by using the voice generation application/web while adjusting the plurality of components of the voice signal. These components can include frequency, waveform, and loudness of the voice signal.

The API 215 can receive a voice signal selected by the owner or the user through the personal terminal 10 or 50, or a voice signal generated or tuned by the owner or the user by using the personal terminal 10 or 50, through the personal terminal 10 or 50. The API 215 can transmit the received voice signal to the voice model database 214, and the voice model database 214 can match the corresponding voice signal to at least one of the owner or the user, the owner character or the user character, and a group to which the owner or the user belongs and store the matched voice signal. This feedback structure can allow the voice model database 214 to update its voice signal data. Thus, the voice AI processor 212 can be provided with a circulation learning structure for generating a voice signal and receiving feedback on the voice signal from an owner and user.

The system server 20 can generate motion information for each of the vehicle character, the owner character, and the user character, and apply the generated motion information to each of the characters.

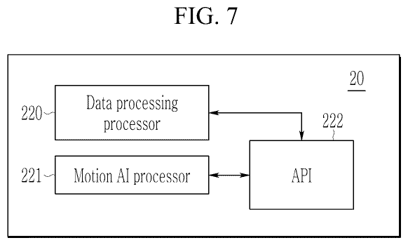

FIG. 7 is a block diagram illustrating an example of configurations for determining an operation for a character in the system server.

The system server 20 can include a data processing processor 220, a motion AI processor 221, and an API 222.

The data processing processor 220 can process image data provided through the API 222 to extract motion data of human movements or article movements that exhibit a specific motion, and can convert the extracted motion data into animations to generate animation data. The image data can be various images including images of actual human motions or article movements, images generated by a video-generating AI, such as Sora, and can be provided externally to the API 222. The process by which the data processing processor 220 extracts motion data from the captured image data can be implemented with algorithms built through machine learning training. Various known machine learning techniques can be used.

The motion AI processor 221 can combine the animation data into animated motion data by using an AI algorithm and provide the animated motion data to the API 222. The AI algorithm can use various known techniques, including generative AI.

The metaverse server 100 can provide a metaverse market for providing characters, voices, motions, and the like. In addition to the characters, voices, motions, and the like, provided by the system server 20, a person authorized to access the metaverse market through the metaverse server 100 (hereinafter, referred to as a metaverse user) can directly generate scenarios with characters, voices, motions, and the like through an application installed on the terminal or the web, and upload the generated scenario to the metaverse market for sale.

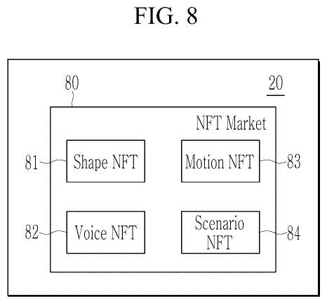

FIG. 8 is a block diagram schematically illustrating an example of an NFT market provided in a metaverse environment.

FIG. 8 illustrates an NFT market to which NFTs associated with shape, voice, motion, and scenario can be uploaded, as an example of a metaverse market.

The metaverse user can generate shapes, voices, motions, and scenarios, and request the system server 20 to generate NFTs for the generated content. Upon request, system server 20 can generate and associate NFTs with the provided content. The metaverse user can upload a shape NFT 81, a voice NFT 82, a motion NFT 83, and a scenario NFT 84 to the NFT market 80. In response to requests from the plurality of metaverse users, the system server 20 can provide the NFT market 80 formed of the plurality of NFTs.

The system server 20 can associate the NFT for the vehicle with the NFT purchased in the NFT market 80. The owner or the user may purchase at least one of the shape NFT 81, the voice NFT 82, the motion NFT 83, and the scenario NFT 84 from the NFT market 80 through the personal terminal 10 or 50 and request the system server 20 to associate the purchased NFT with the NFT for the vehicle. The system server 20 can link the purchased NFT to the vehicle NFT upon request.

The system server 20 may sell the associated NFTs along with the NFT for the vehicle upon selling the vehicle. Through this, not only the NFT for the vehicle but also the NFT with sale value can be secured, and various metaverse users may be attracted. This can enhance engagement, making the metaverse system more active.

What is claimed is:

1. A non-fungible token (NFT) service system connected to a terminal of an owner or a user, the NFT service system comprising:
a blockchain mainnet configured to issue an NFT based on manufacturing characteristic information of a vehicle; and
a system server, implemented using a plurality of processors, configured to:
generate (i) a vehicle character representing the vehicle and (ii) an owner character or a user character representing the owner or user, respectively, and
associate the vehicle character and the owner character or user character to the NFT.

2. The NFT service system of claim 1, wherein the system server is configured to:
issue a derivative NFT associated with the NFT through the blockchain mainnet, the derivative NFT being associated with the user,
store information of the user in a block of the blockchain mainnet by using the derivative NFT, and
use the derivative NFT to authenticate the user on the blockchain.

3. The NFT service system of claim 2, wherein:
the system server is configured to, based on a change in information regarding the user in a metaverse being detected, update changed information in the blockchain using the derivative NFT.

4. The NFT service system of claim 2, wherein the system server is configured to:
store, to the blockchain associated with the NFT, at least one of changes in vehicle characteristics or changes in ownership, and
store, in the blockchain associated with the derivative NFT, information regarding the changes.

5. The NFT service system of claim 1, wherein the system server is configured to provide, to the terminal, access to a vehicle production process.

6. The NFT service system of claim 5, wherein the system server is configured to:
based on the owner of the vehicle being identified, set a permission for the owner character to access the vehicle production process in a metaverse, and
provide, to the terminal of the owner, access to the vehicle production process in response to metaverse connection of the owner character through the terminal of the owner.

7. The NFT service system of claim 1, wherein the system server includes:
a database including direct and indirect information regarding each of the vehicle and the owner or the user;
a first processor configured to obtain text and prompts representing attributes of a character subject from the information stored in the database;
a second processor configured to obtain character metadata for generating the character, represented as vector values or numerical data, based on attributes inherent to the text and the prompts;
a graphics AI processor configured to generate the character using the information stored in the database and the character metadata; and
an Application Processor Interface (API) providing an interface between the first processor, the second processor, the graphics AI processor, and the database.

8. The NFT service system of claim 7, wherein the first processor is configured to:
perform morphological analysis to remove one or more contents from sentences utilized by the owner or the user within a text collection environment,
collect text based on content words by excluding non-words from sentences utilized by the owner or the user,
apply text mining to the collected text to structure collected data, and
apply text analysis to the structured text to obtain quantified data regarding the structured text.

9. The NFT service system of claim 7, wherein the system server further includes:
a third processor configured to tune a character received from the terminal based on the character metadata,
wherein one of the character generated by the second processor, the character tuned by the third processor, or the character received from the terminal to the system server is determined and delivered to the database via the API, and
wherein the database is configured to store the character delivered via the API by matching the character to a corresponding subject.

10. The NFT service system of claim 1, wherein the system server includes:
a database including direct and indirect information regarding the vehicle and the owner or the user;
a fourth processor configured to obtain text and prompts including voice metadata for generating voice from the database;
a fifth processor configured to generate voice metadata from the text and prompts;
a voice model database storing voice data according to a plurality of factors;
a voice AI processor configured to generate voice data corresponding to the voice metadata using the voice data stored in the voice model database; and
a voice generation processor configured to convert the voice data corresponding to the voice metadata into digital signals to generate voice signals.

11. The NFT service system of claim 10, wherein the voice AI processor is configured to perform AI learning to generate voice data corresponding to the voice metadata using a plurality of voice data from the voice model database.

12. The NFT service system of claim 10, wherein the voice generation processor is configured to:
acquire dialogue styles and words according to the character, and word and style information used by a group to which the owner or the user belongs from the voice model database, and
convert the voice data corresponding to the voice metadata into digital signals to generate voice signals according to the acquired dialogue styles, words, and style information.

13. The NFT service system of claim 10, wherein the system server further includes:
an API configured to deliver a voice signal selected by the owner or the user via the terminal, and a voice signal generated or tuned using the terminal received from the terminal to the voice model database,
wherein the voice model database is configured to store the voice signal delivered from the API by matching the voice signal to at least one of the owner or the user, the character of the owner or the user, or a group to which the owner or the user belongs.

14. The NFT service system of claim 1, wherein the system server includes:
a data processing processor configured to process video data to extract motion data regarding movements of a person or movements of an object representing actions, and convert the extracted motion data into animation to generate animation data; and
a motion AI processor configured to combine the animation data into animation motion data using an AI algorithm.

15. The NFT service system of claim 1, wherein the system server is configured to:
provide generation of a plurality of NFTs for a plurality of contents, and providing an NFT market by associating the plurality of contents to the plurality of NFTs, and
associate an NFT purchased in the NFT market to the NFT of the vehicle in response to a request from the owner or the user.
